(19) United States
(12) Patent Application Publication
(10) Pub. No.: US 2024/0104589 A1
(43) Pub. Date: Mar. 28, 2024

(54) PREDICTION OF CONSUMER DEMAND FOR A SUPPLY IN A GEOGRAPHIC ZONE BASED ON UNRELIABLE AND NON-STATIONARY DATA

(71) Applicant: GM GLOBAL TECHNOLOGY OPERATIONS LLC, Detroit, MI (US)

(72) Inventors: Klaus Trangbaek, Ein Vered (IL); Yaron Veksler, Giv'atayim (IL); Oren Herstic, Tel Aviv (IL); Vladimir Suplin, Modiin (IL); Daniel Urieli, Herzliya (IL)

(73) Assignee: GM GLOBAL TECHNOLOGY OPERATIONS LLC, Detroit, MI (US)

(21) Appl. No.: 17/951,156

(22) Filed: Sep. 23, 2022

(51) Int. Cl. G06Q 30/02

(52) U.S. Cl. CPC G06Q 30/0202; G06Q 30/0205

(57) ABSTRACT

A method that includes obtaining demand data, consumer data, and historical demand data, the demand data represents a demand of consumers for a supply over a past time period in a geographic zone. The demand data includes a recent time segment having unreliable demand information. The consumer data. The method further includes, based on the demand data, estimating a scalar of the demand, and, based on the historical demand data, modeling a standardized model demand profile of mean demand over multiple past time periods. Further, the method includes producing a short-term demand prediction of the consumers of the supply over a portion of a forthcoming time period. The short-term demand prediction is based, at least in part, on the standardized model demand profile, the demand data, and the consumer data.

### INTRODUCTION

This disclosure relates to techniques for the prediction of consumer demand for a supply in a geographic zone based on unreliable data.

It's anticipated that around half of all new vehicle sales will be all-electric by 2030. Thus, a large number of battery electric vehicles (BEV) will be hitting the road in near future. The demand for charging these new BEVs presents a significant challenge to the electricity infrastructure. In some estimates, the annual demand for electricity to charge these new BEVs would surge from eleven billion kilowatt-hours (kWh) in 2020 to two-hundred thirty billion kWh in 2030.

### SUMMARY

According to one embodiment, a method for facilitating a prediction of demand of consumers for a supply in a geographic zone that includes: 1) obtaining demand data, consumer data, and historical demand data, the demand data represents a demand of consumers for a supply over a past time period in a geographic zone, wherein the demand data includes a recent time segment having unreliable demand information, the consumer data includes information regarding demand properties and status of the consumers for the supply over the past time period in the geographic zone, and the historical demand data represents a demand of consumers for the supply over multiple past time periods in the geographic zone; 2) based on the demand data, estimating a scalar of the demand over the past time period; 3) based on the historical demand data, modeling a standardized model demand profile of mean demand over the multiple past time periods; 4) producing a short-term demand prediction of the consumers of the supply over an immediate portion of a forthcoming time period in the geographic zone, wherein the short-term demand prediction is based, at least in part, on the standardized model demand profile, the demand data, and the consumer data and the short-term demand prediction includes, at least in part, being a product of the scalar and the standardized model demand profile; and 5) presenting the short-term demand prediction.

In this embodiment, the method may further include 1) producing a demand prediction of the consumers of the supply over the forthcoming time period in the geographic zone, wherein the demand prediction is based, at least in part, on the standardized model demand profile and the demand prediction includes, at least in part, a product of the scalar and the standardized model demand profile; and 2) presenting the demand prediction.

With this embodiment, the method may further include 1) based on the consumer data, generating a standardized capacity profile of capacity over the past time period; 2) producing a capacity prediction of the consumers of the supply over the forthcoming time period in the geographic zone, wherein the capacity prediction includes, at least in part, a product of the scalar and the standardized capacity profile and 3) presenting the capacity prediction.

With the geographic zone including multiple territories with the short-term demand prediction produced for each territory, some implementations of the method further includes generating an aggregated multi-territorial prediction based on the short-term demand predictions produced for each territory.

In other embodiments of the method, the past time period is one that immediately precedes a present time of prediction and/or includes demand data containing near-stationary data. In still other embodiments, the past time period and the forthcoming time period match in length.

In some embodiments of the method, the supply is, for example, water, electricity, fuel, oil, power, energy, natural gas, propane, food, feed, and/or the like. In still other embodiments, the consumers are electrical vehicles that charge using an electrical supply. In still another embodiment, the past time period and the forthcoming time period match in length.

According to another embodiment, a method includes 1) obtaining demand data and historical demand data, the demand data represents a demand of consumers for a supply over a past time period in a geographic zone, wherein the demand data includes a recent time segment having unreliable demand information and the historical demand data represents a demand of consumers for the supply over multiple past time periods in the geographic zone; 2) based on the demand data, estimating a scalar of the demand over the past time period; 3) based on the historical demand data, modeling a standardized model demand profile of mean demand over the multiple past time periods; 4) producing a demand prediction of the consumers of the supply over a forthcoming time period in the geographic zone, wherein the demand prediction is based, at least in part, on the standardized model demand profile and the demand prediction includes, at least in part, a product of the scalar and the standardized model demand profile; and 5) presenting the demand prediction.

With another embodiment, the method may further include 1) obtaining consumer data that includes information regarding demand properties and status of the consumers for the supply over the past time period in the geographic zone; 2) based on the consumer data, generating a standardized capacity profile of capacity over the past time period; 3) producing a capacity prediction of the consumers of the supply over the forthcoming time period in the geographic zone, wherein the capacity prediction includes, at least in part, a product of the scalar and the standardized capacity profile; and 4) presenting the capacity prediction.

In another embodiment, the demand data includes a recent time segment having unreliable demand information, the method further includes: 1) obtaining consumer data that includes information regarding demand properties and status of the consumers for the supply over the past time period in the geographic zone; 2) producing a short-term demand prediction of the consumers of the supply over an immediate portion of a forthcoming time period in the geographic zone, wherein the short-term demand prediction is based, at least in part, on the standardized model demand profile, the demand data, and the consumer data and the short-term demand prediction includes, at least in part, being a product of the scalar and the standardized model demand profile; and 3) presenting the short-term demand prediction.

With the geographic zone including multiple territories with the short-term demand prediction produced for each territory, some implementations of the method further includes generating an aggregated multi-territorial prediction based on the short-term demand predictions produced for each territory.

In other embodiments of this method, the consumers are electrical vehicles that charge using an electrical supply. In still other embodiments, this method may further include calculating a confidence interval of the demand prediction as a function of the scalar. According to yet another embodiment, a non-transitory machine-readable storage medium encoded with instructions executable by one or more processors that, when executed, direct the one or more processors to perform operations for facilitating a prediction of demand of consumers for a supply in a geographic zone. These operations include 1) obtaining demand data, consumer data, and historical demand data, the demand data represents a demand of consumers for a supply over a past time period in a geographic zone, wherein the demand data includes a recent time segment having unreliable demand information, the consumer data includes information regarding demand properties and status of the consumers for the supply over the past time period in the geographic zone, and the historical demand data represents a demand of consumers for the supply over multiple past time periods in the geographic zone; 2) based on the demand data, estimating a scalar of the demand over the past time period; 3) based on the historical demand data, modeling a standardized model demand profile of mean demand over the multiple past time periods; 4) producing a short-term demand prediction of the consumers of the supply over an immediate portion of a forthcoming time period in the geographic zone, wherein the short-term demand prediction is based, at least in part, on the standardized model demand profile, the demand data, and the consumer data and the short-term demand prediction includes, at least in part, being a product of the scalar and the standardized model demand profile; and 5) presenting the short-term demand prediction.

The non-transitory machine-readable storage medium may further include instructions to perform operations that 1) produce a demand prediction of the consumers of the supply over the forthcoming time period in the geographic zone, wherein the demand prediction is based, at least in part, on the standardized model demand profile and the demand prediction includes, at least in part, a product of the scalar and the standardized model demand profile; and 2) presenting the demand prediction.

The non-transitory machine-readable storage medium may further include instructions to perform operations that: 1) based on the consumer data, generate a standardized capacity profile of capacity over the past time period; 2) produce a capacity prediction of the consumers of the supply over the forthcoming time period in the geographic zone, wherein the capacity prediction includes, at least in part, a product of the scalar and the standardized capacity profile; and 3) present the capacity prediction.

With the geographic zone including multiple territories with the short-term demand prediction produced for each territory, some implementations of the non-transitory machine-readable storage medium may further include instructions to perform operations that generate an aggregated multi-territorial prediction based on the short-term demand predictions produced for each territory.

In still other embodiments of the non-transitory machine-readable storage medium, the consumers are electrical vehicles that charge using an electrical supply.

The above features and advantages, and other features and advantages of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

FIG. 1 illustrates an example scenario suitable to utilize an example prediction system for consumer demand for a supply in a geographic zone based on unreliable data, in accordance with one or more implementations described herein.

FIG. 2 illustrates an example data flow diagram of the example prediction system for consumer demand for a supply in a geographic zone based on unreliable data, in accordance with one or more implementations described herein.

FIG. 3 illustrates an example of computer architecture for a computing system capable of executing the technology described herein.

FIG. 4 is a flowchart illustrating a process to perform an example method of short-term demand prediction.

FIG. 5 is a flowchart illustrating a process to perform an example method of demand prediction.

FIG. 6 is a flowchart illustrating a process to perform an example method of capacity prediction.

### DETAILED DESCRIPTION

Referring now to the drawings, wherein like numerals indicate like parts in the several views of various systems and approaches are shown and described herein.

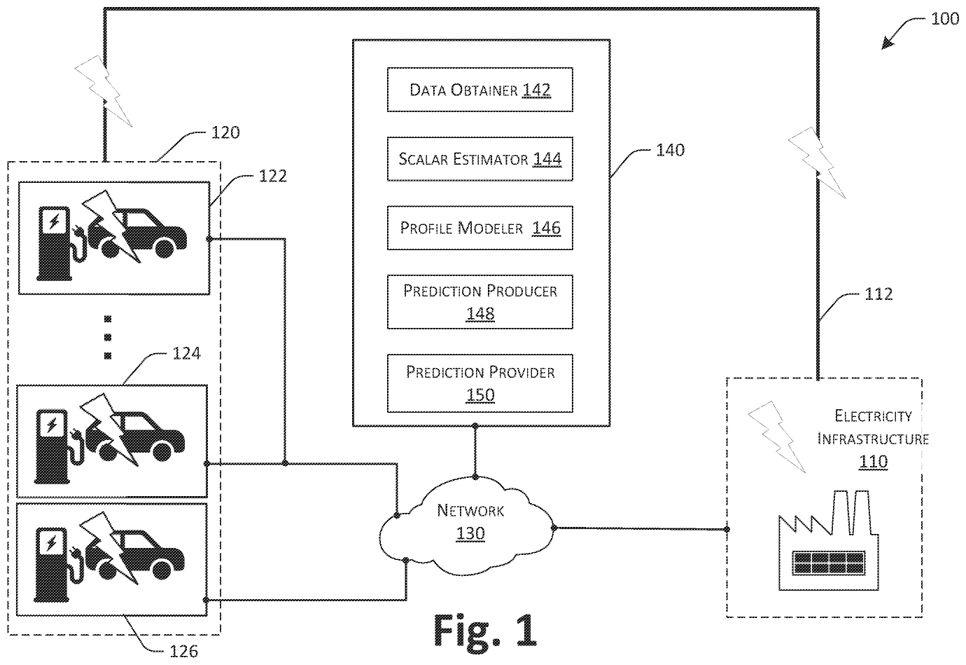

FIG. 1 illustrates an example scenario 100 suitable to utilize an example demand prediction system 140 for consumer demand for a supply in a geographic zone (such as a territory 120) based on incomplete data, in accordance with one or more implementations described herein.

The example scenario 100 includes electricity infrastructure 110, which includes, for example, equipment and services employed to take electrical energy generated from electrical power sources and transmit it to end-use residential, commercial, and industrial customers. Electricity power sources include power plants based on hydroelectric dams, fossil fuels (e.g., coal, natural gas, or oil), and nuclear, solar, wind, geothermal, and biomass power plants. Such infrastructures are often owned and managed by organizations often called electrical utilities. In some instances, the infrastructure may be called an electrical grid.

The electricity infrastructure 110 is connected via electrical transmission media 112 to the customers in territory 120 served by the electricity infrastructure 110. Such customers may be homes or businesses in that territory. As depicted, homes 122, 124, and 126 are homes in territory 120 that are equipped to charge a battery electric vehicle (BEV) from the power coming from the electricity infrastructure 110. Homes 122, 124, and 126 are merely examples of the many more homes in the territory that are BEV-charging equipped.

As used herein, a geographic zone is a generic name for a physical area that draws a load from the electricity infrastructure 110. Thus, the infrastructure delivers power to the consumers in a geographic zone. More particularly, the territory is the smallest unit of a geographic zone served or measured using the techniques described herein. Examples of territories include ZIPCODE area, county, city, state, and the like. And a region is a collection of territories that are served by the same infrastructure, but such territories need not be contiguous with each other.

The BEVs are examples of consumers of an electrical load supplied by the electricity infrastructure 110. Thus, the BEVs are providing the demand for power, and the electricity infrastructure 110 are supplying that power. Unless the context indicates otherwise, a consumer, herein, are those that generate or cause a demand for a supply from a supplier.

Such supplies are those that may be or are typically supplied on a continuous or ongoing basis. That is, such supplies are provided on-demand or nearly so because the demand for such supplies, while variable, is unfaltering. Examples of such supplies may be, for example, water, electricity, fuel, oil, power, energy, natural gas, propane, food, feed, and/or the like.

A network 130 connects the prediction system 140 to the homes of territory 120 and the electricity infrastructure 110. Network 130 is a collection of interconnected computing devices (i.e., network nodes) that use a set of common communication protocols over digital interconnections to share resources or services located on or provided by the network nodes. The interconnections between nodes are formed from one or more of a broad spectrum of telecommunication network technologies, based on physically wired, optical, and wireless radio-frequency methods that may be arranged in a variety of network topologies. The so-called cloud and the so-called Internet are examples of a suitable communications network.

It should be appreciated that the configuration and network topology described herein has been dramatically simplified and that many more computing systems, software components, networks, servers, services, and networking devices can be utilized to interconnect the various computing systems disclosed herein and to provide the functionality described herein.

The prediction system 140 is shown as simplified functional block. The prediction system includes a data obtainer 142, a scalar estimator 144, a profile modeler 146, a prediction producer 148, and a prediction provider 150. Each functional block of the prediction system 140 may be implemented, at least in part, by hardware, firmware, or by a combination thereof with software.

The prediction system 140 utilizes information about past demands of consumers, such as the BEVs of the homes in territory 120, to predict future demand. The prediction system 140 may provide its demand prediction to the electricity infrastructure 110, for example, so that the infrastructure can plan accordingly to have sufficient supply to meet the expected demand promptly.

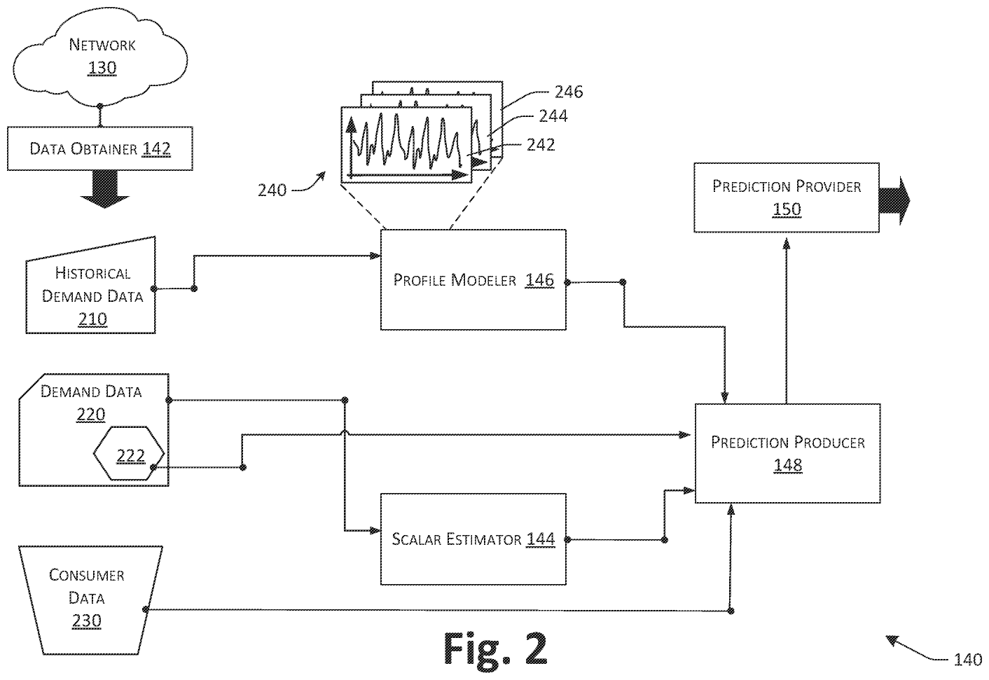

FIG. 2 illustrates an example data flow diagram of the prediction system 140 for consumer demand for the electrical supply in a geographic zone based on unreliable and non-stationary data, in accordance with one or more implementations described herein.

Via network 130, the data obtainer 142 collects demand data 220 and historical demand data 210 from, for example, consumers of the electric load provided by the electricity infrastructure 110 in the geographic zone (such as the territory 120). Such consumers may include, for example, the BEVs in homes 122, 124, and 126 as shown in FIG. 1.

More particularly, the demand data 220 represents, by and large, the measured demand of consumers in a geographic zone (such as BEVs in the homes in the territory 120) over a defined elapsed time period as projected back from a defined present point in time for the prediction (e.g., a present time of prediction). Herein, the defined elapsed time period may be called the past time period. With one or more implementations described herein, the demand data 220 is recent data, such as from the past week.

For example, the demand data 220 may provide the mean load demand of the BEVs in territory 120 over the past week (i.e., 168 hours). In this case, the past time period is 168 hours or one week from the present time of prediction. In this instance, one week is utilized because the demand pattern of consumers tends to repeat every week. The chosen time period may vary for other types of demands and supplies.

In addition, a portion 222 of the demand data 220 is unreliable. That is, the data of the portion 222 may be only partially observed or potentially incomplete. The unreliable portion 222 (i.e., unreliable demand information), it is not known whether measured demand does accurately reflect the actual demand. This may occur, for example, with the most recent measurements. Some of the charging meter package the demand data once the charging session is complete. In this instance, the demand data lacks data about charging BEVs. While the charging BEVs are pulling a load, the idiosyncratic nature of the charging meter fails to capture that demand data until, presumably, after the present time of prediction. Consequently, the demand data 220 includes a recent time segment (e.g., 24 hours) having unreliable demand information.

Because the BEV market continues to grow, the historical demand data of the charging demand of BEVs in a given geographic zone is non-stationary. Non-stationary data have means, variances, and/or covariances that change over time. Non-stationary behaviors can be trends, cycles, random walks, or combinations of the three. Non-stationary data, as a rule, are unpredictable and cannot be modeled or forecasted. Regardless, this demand data can be used as a basis for predictions using the technology described herein.

Two factors accommodate for the non-stationary data. First, is the separation of values into a scalar and a standardized value. This will be further below in the context of the scalar estimation. Second, a piece of the data is selected for being as near stationary as possible. For example, it may be presumed in some instances that the data associated with a time closest to the present will be as near stationary as possible. Thus, the past week is used for the demand data.

As used herein, near-stationary data is a set of data that most closely resembles or matches the conditions being predicted. For example, the past week of demand is near-stationary data because the conditions mostly closely represent the present and the next week that is being predicted.

The historical demand data 210 includes the same measured demand of consumers in a geographic zone (such as BEVs in the homes in territory 120); however, the historical demand data stretches back further into the past. Indeed, the historical demand data 210 extends over multiple past time periods. For example, the historical demand data 210 employed by one or more implementations described herein extends back a year (e.g., fifty-two weeks). With one or more implementations described herein, the historical demand data 210 is not recent data. For example, it may be data from other past weeks other than just the past week.

This is an example of multiple time periods: having a given number (e.g., X) periods of several (e.g., Y) samples each. The mean profile will be Y samples, each sample an average of X corresponding samples.

In addition, data obtainer 142 gathers consumer data 230, which includes information regarding the demand properties and the status of the consumers for the supply over the past time period in the geographic zone. For example, consumer data may include information about the demand properties and status of the BEVs of the customers of the electricity infrastructure 110 in territory 120 over the past week.

Demand properties may include, for example, the number of consumers (e.g., BEVs) in a geographic zone (e.g., territory 120). Demand status may include the charging state (e.g., fully charged, charging, etc.) of the consumers (e.g., BEVs) in the geographic zone.

The scalar estimator 144 calculates a scalar of the demand over the past time period (e.g., one week) based on the demand data 220 from that time period. It is anticipated that the absolute value of the mean demand of the demand data and historical demand data may vary greatly over the past time period and this may be even more so when the absolute value of the mean demand is compared to other past time periods. Thus, the demand data and historical demand data may be handled in a standardized (e.g., normalized) way so that profiles from various time periods may be effectively compared.

The actual value of the mean demand in the data at a point in time is a product of the scalar and the value of the standardized mean demand at that same point in time. For example, an actual mean demand of the eighteenth hour of the sample set may have a value of 15 kWh. When standardized, the mean demand of the eighteenth hour may be 3 kWh and the scalar may be 5. Thus, the mathematical product of the scalar (5) and the standardized mean demand (3 kWh) is 15 kWh. Thus, the mean demand value and the choice of standardization determine the value of the scale. Since the scalar is derived from the past week, it is presumed to be near-stationary data.

With one or more implementations described herein, the mean demand may be one that is determined or discretized per unit time. That is, the mean demand may be described as mean-demand per time-step in a period. For example, it may be the mean demand per hour in past week.

With the scalar estimator 144, the scalar is determined based on the mean demand values across the past time period and the choice or scale of standardization. The standardization choice may be manually selected, procedurally generated, or determined using ML techniques.

The profile modeler 146 generates profiles 240 based on the historical demand data 210 utilizing machine learning (ML) techniques. A profile represents the mean demand over time. It may be visualized as mean demand graphed on an X-axis and time graphed on a Y-axis.

As depicted, the profile 240 includes a standardized model demand profile 242, a standardized demand profile 244, and a standardized capacity profile 246. Each of these profiles is standardized (e.g., normalized) in a manner like that discussed above.

Based on its incoming data, the profile modeler 146 employs data profiling (i.e., data modeling) using machine learning (ML) techniques, such as linear and logical regression. In doing so, the profile modeler 146 models one or more reoccurring patterns in a large dataset.

For example, the profile modeler 146 may generate the standardized model demand profile 242 of the mean demand over each week of the past fifty-two weeks (e.g., one year) from the historical demand data 210. In another example, the profile modeler 146 may generate the demand profile 244 of the mean demand over the past week (e.g., 168 hours) from the demand data 220. In still another example, the profile modeler 146 may generate the capacity profile 246 of the capacity over the past week (e.g., one year) from the consumer data 230.

As noted above, the unreliable demand information may fail to accurately capture the mean demand during the recent time segment (e.g., the last 24 hours). While the charging BEVs are pulling a load, the idiosyncratic nature of the charging meter fails to capture that demand data until, presumably, after the present time of prediction. To accommodate for this, the profile modeler 146 uses a segment of the model/profile that it has already created over historical time periods to map/model the demand data more accurately.

Furthermore, the profile modeler 146 may generate the standardized capacity profile 146 over the past time period (e.g., one week) in a geographic zone (e.g., territory 120). The capacity may be, for example, maximum likely demand over a given time period in the geographic zone. In some implementations, it may be literally the maximum demand over the given time period in that zone based on the defined conditions. In other instances, the capacity may be a delayable demand.

For example, an initial capacity may be calculated, at least in part, by multiplying the number of consumers in a geographic zone by the maximum load pulled for charging each customer over a defined time period (e.g., one week). The capacity may be further adjusted by accommodating customers (e.g., BEVs) that are already fully charged (thus, do not need additional charging). The demand properties may provide the number of consumers (e.g., BEVs) in a geographic zone (e.g., territory 120). Demand status may include the charging state (e.g., fully charged, charging, etc.) of the consumers (e.g., BEVs) in the geographic zone.

The prediction producer 148 produces one or more predictions of the demand and/or capacity of the consumers (e.g., BEVs) of the electrical supply from the electricity infrastructure 110 over a forthcoming time period (e.g., one week) in a geographic zone (e.g., the territory 120). The predictions occur at a present period of prediction, which can be generally called the present. Of course, such predictions are about the unknown future. The forthcoming time period, as described herein, is set in a future that is beyond the present.

With some of the implementations described herein, the forthcoming time period matches the past time period in length. For example, with the past time period being one week (e.g., 168 hours), the forthcoming time period is also one week in length. Other implementations may utilize different matching time periods. And still other implementations may use non-matching time periods. For example, a three-day past time period may be the basis for a prediction over a two-week forthcoming time period. Also, in some implementations, the forthcoming time period begins immediately after the present. In other implementations, the forthcoming time period may begin after some offset (i.e., time passing) after the present.

The prediction producer 148 produces a short-term demand prediction of the consumers (e.g., BEVs) of the electrical supply from the electricity infrastructure 110 over an immediate portion (e.g., 24 hours) of the forthcoming time period (e.g., one week) in a geographic zone (e.g., the territory 120). Using ML techniques, the prediction producer 148 makes the short-term prediction is based, at least in part, on the standardized model demand profile, the demand data, and the consumer data The prediction producer 148 may accomplish this, at least in part, by producing the mathematical product of the scalar and the short-term standardized demand profile. Thus, the prediction producer 148 multiplies the scaler with the short-term standardized demand profile. The prediction producer 148 sends the produced short-term demand prediction to the prediction provider 150.

The prediction producer 148 may produce a demand prediction of the consumers of the supply over a forthcoming time period in the geographic zone. The demand prediction may be based, at least in part, on the standardized model demand profile. Further, the demand prediction includes, at least in part, a product of the scalar and the standardized model demand profile.

The prediction producer 148 may produce a capacity prediction of the consumers of the supply over a forthcoming time period in the geographic zone. The capacity prediction may be based, at least in part, on the standardized capacity profile. Further, the capacity prediction includes, at least in part, a product of the scalar and the standardized capacity profile.

Similar to what was discussed above about the relationship between the past time period and the forthcoming time period, the immediate portion of the forthcoming time period matches the recent portion of the past time period in length. For example, with the recent portion being twenty-four hours, the immediate portion is also twenty-four hours in length. Other implementations may utilize different matching time periods for these portions. And still other implementations may use non-matching time periods for these portions. Also, in some implementations, the immediate portion begins immediately after the present and/or immediately after the recent portion. In other implementations, the immediate portion may begin after some offset (i.e., time passing) after the present.

In addition, the prediction producer 148 may produce a demand prediction of the consumers (e.g., BEVs) of the electrical supply from the electricity infrastructure 110 over the forthcoming time period (e.g., one week) in a geographic zone (e.g., the territory 120). The prediction producer 148 may accomplish this, at least in part, by producing the mathematical product of the scalar and the standardized demand profile. Thus, the prediction producer 148 multiplies the scaler with the standardized demand profile. The prediction producer 148 sends the produced demand prediction to the prediction provider 150.

Further, the prediction producer 148 may produce a capacity prediction of the consumers (e.g., BEVs) of the electrical supply from the electricity infrastructure 110 over the forthcoming time period (e.g., one week) in a geographic zone (e.g., the territory 120). The prediction producer 148 may accomplish this, at least in part, by producing the mathematical product of the scalar and the standardized capacity profile. Thus, the prediction producer 148 multiplies the scaler with the standardized capacity profile. The prediction producer 148 sends the produced capacity prediction to the prediction provider 150.

The predictions may cover a single territory (such as territory 120) or they may cover a combination of territories. A combination of territories is called a region herein. The number of consumers in a given territory may be sparse. Indeed, it may be too sparse to produce good predictions. Thus, multiple sparse territories may be combined to form a region that collectively has sufficient data to produce effective predictions. In these instances, the prediction provider 150 may generate an aggregated multi-territorial prediction based on the short-term demand, demand, and/or capacity predictions produced for each territory.

The prediction provider 150 sends one or more of the short-term demand prediction, demand prediction, and capacity prediction to one or more receivers. An example of a receiver is the electrical utilities of the electricity infrastructure 110. Based on these predictions, the electrical utilities may plan accordingly for the upcoming load.

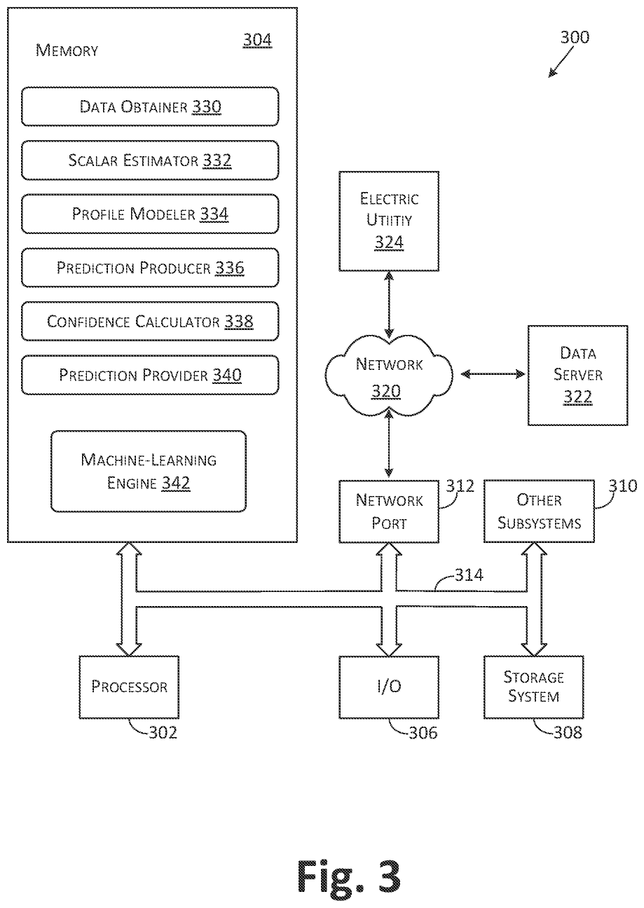

FIG. 3 illustrates an example of computer architecture for a computing system 300 capable of executing the technology described herein. The computer architecture shown in FIG. 1 illustrates a typical computer, server computer, workstation, desktop computer, laptop, tablet, network appliance, e-reader, smartphone, or another computing device. It can be utilized to execute the functionalities presented herein.

The computing system 300 includes a processor 302 (e.g., central processor unit or “CPU”), a system storage (e.g., memory) 304, input/output (I/O) devices 306—such as a display, a keyboard, a mouse, and associated controllers, a secondary storage system 308 (e.g., a hard drive), and various other subsystems 310. In various embodiments, the computing system 300 also includes network port 312 operable to connect to a network 320, which is likewise accessible by a data server 322 and electric utility 324. The foregoing components are interconnected via one or more buses 314.

System memory 304 may store data and machine-readable instructions (e.g., computer-readable instructions). The computing system 300 may be configured by machine-readable instructions. Machine-readable instructions may include one or more instruction modules. The instruction modules may include computer program modules. The instruction modules may include one or more of the data obtainer module 330, scalar estimator module 332, profile modeler module 334, prediction producer module 336, confidence calculator module 338, prediction provider module 340, machine-learning engine 342, and/or other instruction-based modules.

The data obtainer module 330 collects data from the consumers (e.g., BEVs) of a supply provided by, for example, the electrical utility 324 in a defined geographic zone (e.g., territory 120). The data obtainer module 330 may receive its data from one or more systems, such as data server 322. The data obtainer module 330 functions like the data obtainer 142 depicted in FIGS. 1 and 2 and their accompanying description above.

The scalar estimator module 332 calculates a scalar of the demand over the past time period (e.g., one week) based on the demand data from that time period. The scalar estimator module 332 functions like the scalar estimator 144 depicted in FIGS. 1 and 2 and their accompanying description above.

The profile modeler module 334 generates standardized profiles based on the data collected by the data obtainer module 330. The profile modeler module 334 functions like the profile modeler 146 depicted in FIGS. 1 and 2 and their accompanying description above.

The prediction producer module 336 produces one or more predictions of the demand and/or capacity of the consumers (e.g., BEVs) of the electrical supply from the electrical utility 324 over a forthcoming time period (e.g., one week) in a geographic zone (e.g., the territory 120). The prediction producer module 336 functions like the prediction producer 148 depicted in FIGS. 1 and 2 and their accompanying description above.

The confidence calculator module 338 calculates a confidence interval. The confidence interval is a function of the scalar. The confidence interval is found by fitting piece-wise affine functions to prediction results on past data. For example, there may be multiple predictions resulting from a variety of zones. Each zone results in a scalar and prediction error interval. Then the system fits a function scalar->interval size. Note that for an aggregate prediction of several territories, the confidence interval of the aggregated prediction will be a function of the aggregated scalar.

The prediction provider module 340 sends one or more of the produced predictions to the electrical utility 324. In some implementations, the prediction provider module 340 also provides the confidence value calculated by the confidence calculator module 338 to the electrical utility 324. The prediction provider module 340 functions like the prediction provider 150 depicted in FIGS. 1 and 2 and their accompanying description above.

The machine-learning engine 342 is employed by the profile modeler 334 to generate a predictive model based on the data gathered by the data obtainer 330. The machine-learning engine 342 may be employed by the prediction producer module 336 in order to produce its predictions.

Machine learning is an application of artificial intelligence (AI) that provides systems the ability to learn and improve from experience without being explicitly programmed. Machine learning techniques build a mathematical model based on sample data, which may be called “training data,” to make predictions or decisions without being explicitly programmed to do so. This mathematical model combines a computer application and data to produce a machine learning (ML) model that is used to create the profiles described herein. ML models may be, for example, linear regression or logistic regression models.

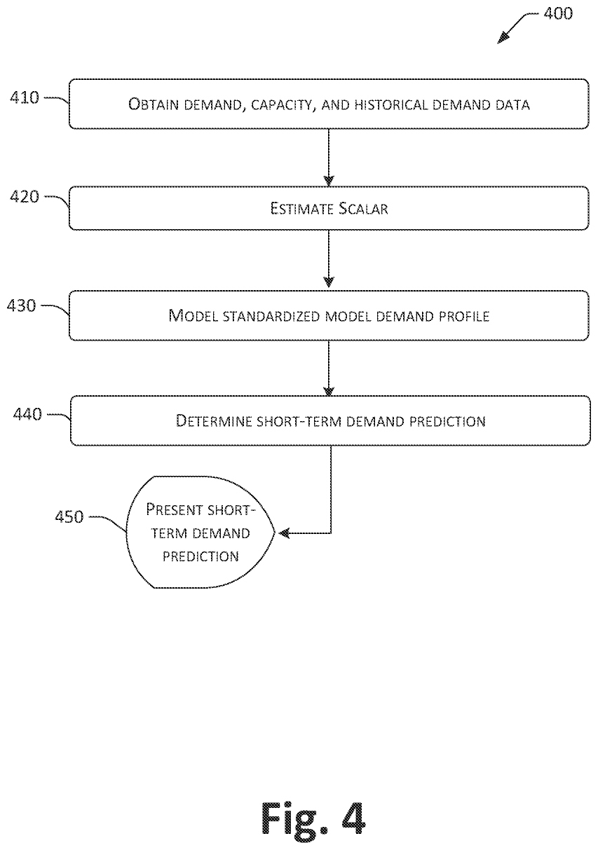

FIG. 4 is a flowchart illustrating a process 400 to perform an example method of short-term demand prediction. For ease of illustration, process 400 may be described as being performed by a device or system described herein, such as the prediction system 140 or the computing system 300. However, process 400 may be performed by other devices or a combination of devices and systems.

At 410, the system obtains demand data, consumer data, and historical demand data. The demand data represents the demand of consumers (e.g., BEVs) for a supply (e.g., electricity from electricity infrastructure 110) over a past time period (e.g., one week) in a geographic zone (e.g., territory 120). The demand data includes a recent time segment (e.g., 24 hours) having unreliable demand information and the historical demand data represents a demand of consumers for the supply over multiple past time periods in the geographic zone.

The consumer data includes information regarding demand properties and the status of the consumers for the supply over the past time period in a geographic zone. The historical demand data represents a demand of consumers for the supply over multiple past time periods in the geographic zone.

At 420, the system estimates a scalar of the demand, based on the demand data, over the past time period.

At 430, the system models a standardized model demand profile, based on the historical demand data, of mean demand over multiple past time periods. The modeling employs ML techniques.

At 440, the system produces a short-term demand prediction of the consumers of the supply over an immediate portion of a forthcoming time period in the geographic zone. The short-term demand prediction is based, at least in part, on the standardized model demand profile, the demand data, and the consumer data. In some implementations, the short-term demand prediction is based, at least in part, on the standardized model demand profile, the unreliable demand data, and the consumer data. The short-term demand prediction includes, at least in part, a product of the scalar and the standardized model demand profile.

At 450, the system presents the short-term demand prediction to an electric utility or other similar users. As used herein, the presenting action of the system includes, for example, displaying, sending, storing, transmitting, processing, associating, and the like. In some implementations, the presenting may include employing the resulting prediction into an automated loop. In such instances, the looping presentation may be useful for bidding in an energy market.

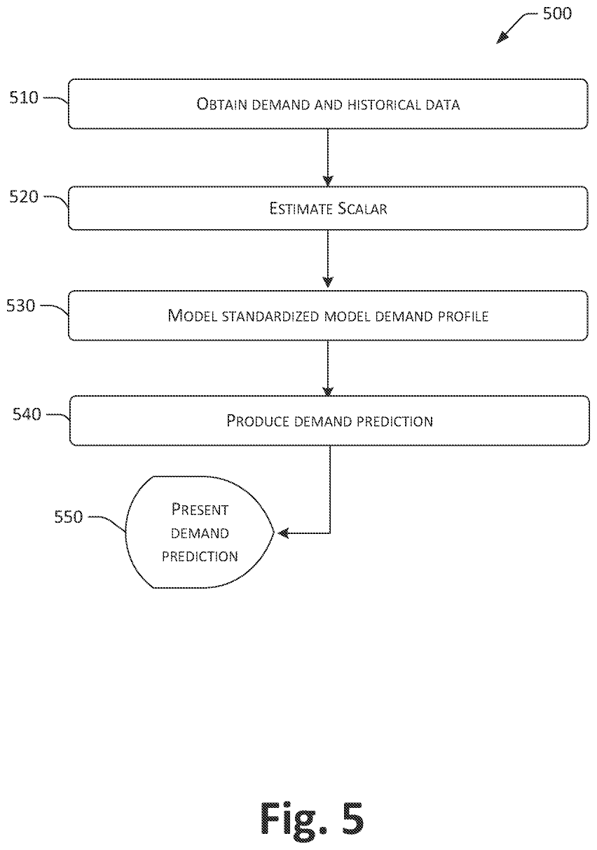

FIG. 5 is a flowchart illustrating a process 500 to perform an example method of demand prediction. For ease of illustration, process 500 may be described as being performed by a device or system described herein, such as the prediction system 140 or the computing system 300. However, process 500 may be performed by other devices or a combination of devices and systems.

At 510, the system obtains demand data and historical demand data. The demand data represents the demand of consumers (e.g., BEVs) for a supply (e.g., electricity from electricity infrastructure 110) over a past time period (e.g., one week) in a geographic zone (e.g., territory 120). The demand data includes a recent time segment (e.g., 24 hours) having unreliable demand information and the historical demand data represents a demand of consumers for the supply over multiple past time periods in the geographic zone. The historical demand data represents a demand of consumers for the supply over multiple past time periods in the geographic zone.

At 520, based on the demand data, the system estimates a scalar of the demand over the past time period.

At 530, based on the historical demand data, the system models a standardized model demand profile of mean demand over the multiple past time periods.

At 540, the system produces a demand prediction of the consumers of the supply over a forthcoming time period in the geographic zone. The demand prediction is based, at least in part, on the standardized model demand profile. The demand prediction includes, at least in part, a product of the scalar and the standardized model demand profile.

At 550, the system presents the demand prediction to an electric utility or other similar users. As used herein, the presenting action of the system includes, for example, displaying, sending, storing, transmitting, processing, associating, and the like. In some implementations, the presenting may include employing the resulting prediction into an automated loop. In such instances, the looping presentation may be useful for bidding in an energy market.

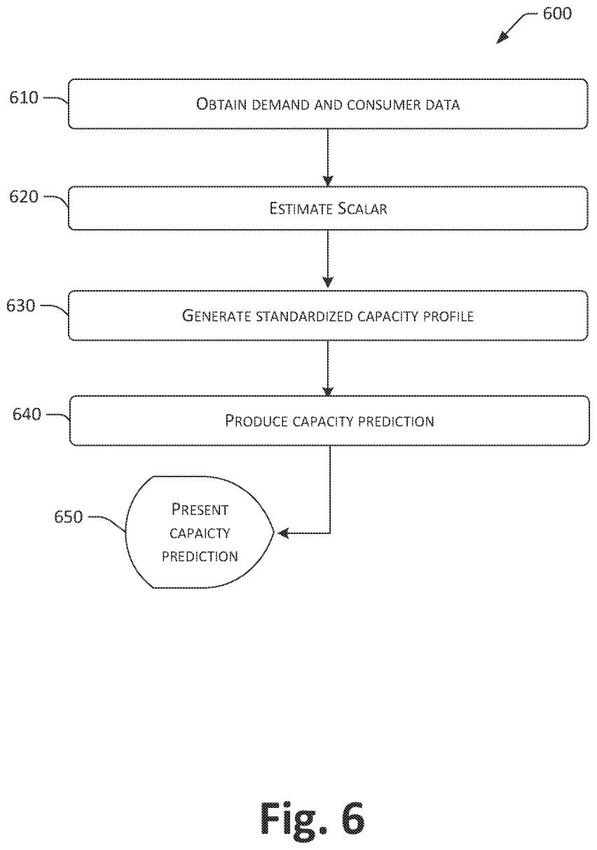

FIG. 6 is a flowchart illustrating a process 600 to perform an example method of capacity prediction. For ease of illustration, process 600 may be described as being performed by a device or system described herein, such as the prediction system 140 or the computing system 300. However, process 600 may be performed by other devices or a combination of devices and systems.

At 610, the system obtains demand data and consumer data. The demand data represents the demand of consumers (e.g., BEVs) for a supply (e.g., electricity from electricity infrastructure 110) over a past time period (e.g., one week) in a geographic zone (e.g., territory 120). The demand data includes a recent time segment (e.g., 24 hours) having unreliable demand information and the historical demand data represents a demand of consumers for the supply over multiple past time periods in the geographic zone. The consumer data includes information regarding demand properties and the status of the consumers for the supply over the past time period in a geographic zone.

At 620, based on the demand data, the system estimates a scalar of the demand over the past time period.

At 630, based on consumer data, the system generates a standardized capacity profile of capacity over the past time period.

At 640, the system produces a capacity prediction of the consumers of the supply over a forthcoming time period in the geographic zone. The capacity prediction includes, at least in part, a product of the scalar and the standardized capacity profile.

At 650, the system presents the capacity prediction to an electric utility or other similar users. As used herein, the presenting action of the system includes, for example, displaying, sending, storing, transmitting, processing, associating, and the like. In some implementations, the presenting may include employing the resulting prediction into an automated loop. In such instances, the looping presentation may be useful for bidding in an energy market.

While various steps of the processes 400, 500, and 600 have been described as being separate blocks, and various functions of the prediction system 140 and computing system 300 have been described as being separate modules, components, or elements, it may be noted that two or more steps may be combined into fewer blocks, and two or more functions may be combined into fewer modules or elements. Similarly, some steps described as a single block may be separated into two or more blocks, and some functions described as a single module or element may be separated into two or more modules or elements. Additionally, the order of the steps or blocks described herein may be rearranged in one or more different orders, and the arrangement of the functions, modules, and elements may be rearranged into one or more different arrangements.

The above description is intended to be illustrative, and not restrictive. While the dimensions and types of materials described herein are intended to be illustrative, they are by no means limiting and are exemplary embodiments. In the following claims, use of the terms “first”, “second”, “top”, “bottom”, etc. are used merely as labels and are not intended to impose numerical or positional requirements on their objects. As used herein, an element or step recited in the singular and preceded by the word “a” or “an” should be understood as not excluding the plural of such elements or steps, unless such exclusion is explicitly stated. Additionally, the phrase “at least one of A and B” and the phrase “A and/or B” should each be understood to mean “only A, only B, or both A and B”. Moreover, unless explicitly stated to the contrary, embodiments “comprising” or “having” an element or a plurality of elements having a particular property may include additional such elements not having that property. And when broadly descriptive adverbs such as “substantially” and “generally” are used herein to modify an adjective, these adverbs mean “mostly”, “mainly”, “for the most part”, “to a significant extent”, “to a large degree” and/or “at least 51 to 99% out of a possible extent of 100%”, and do not necessarily mean “perfectly”, “completely”, “strictly”, “entirely” or “100%”. Additionally, the word “proximate” may be used herein to describe the location of an object or portion thereof concerning another object or portion thereof, and/or to describe the positional relationship of two objects or their respective portions thereof concerning each other, and may mean “near”, “adjacent”, “close to”, “close by”, “at” or the like. And, the phrase “approximately equal to” as used herein may mean one or more of “exactly equal to”, “nearly equal to”, “equal to somewhere between 90% and 110% of” or the like.

This written description uses examples, including the best mode, to enable those skilled in the art to make and use devices, systems and compositions of matter, and to perform methods, according to this disclosure. It is the following claims, including equivalents, which define the scope of the present disclosure.

What is claimed is:

1. A method for facilitating a prediction of a demand of consumers for a supply in a geographic zone, the method comprising:
obtaining demand data, consumer data, and historical demand data, the demand data represents a demand of consumers for a supply over a past time period in a geographic zone, wherein the demand data includes a recent time segment having unreliable demand information, the consumer data includes information regarding demand properties and status of the consumers for the supply over the past time period in the geographic zone, and the historical demand data represents a demand of consumers for the supply over multiple past time periods in the geographic zone;
based on the demand data, estimating a scalar of the demand over the past time period;
based on the historical demand data, modeling a standardized model demand profile of mean demand over the multiple past time periods;
producing a short-term demand prediction of the consumers of the supply over an immediate portion of a forthcoming time period in the geographic zone, wherein the short-term demand prediction is based, at least in part, on the standardized model demand profile, the demand data, and the consumer data and the short-term demand prediction includes, at least in part, being a product of the scalar and the standardized model demand profile; and
presenting the short-term demand prediction.

2. A method of claim 1 further comprising:
producing a demand prediction of the consumers of the supply over the forthcoming time period in the geographic zone, wherein the demand prediction is based, at least in part, on the standardized model demand profile and the demand prediction includes, at least in part, a product of the scalar and the standardized model demand profile; and
presenting the demand prediction.

3. A method of claim 1 further comprising:
based on the consumer data, generating a standardized capacity profile of capacity over the past time period;
producing a capacity prediction of the consumers of the supply over the forthcoming time period in the geographic zone, wherein the capacity prediction includes, at least in part, a product of the scalar and the standardized capacity profile; and
presenting the capacity prediction.

4. A method of claim 1, wherein the geographic zone includes multiple territories with the short-term demand prediction produced for each territory, the method further comprising generating an aggregated multi-territorial prediction based on the short-term demand predictions produced for each territory.

5. A method of claim 1, wherein the past time period is one that immediately precedes a present time of prediction.

6. A method of claim 5, wherein the past time period includes demand data containing near-stationary data.

7. A method of claim 1, wherein the supply is selected from a group consisting of water, electricity, fuel, oil, power, energy, natural gas, propane, food, and feed.

8. A method of claim 1, wherein the consumers are electrical vehicles that charge using an electrical supply.

9. A method of claim 1, wherein the past time period and the forthcoming time period match in length.

10. A method comprising:
obtaining demand data and historical demand data, the demand data represents a demand of consumers for a supply over a past time period in a geographic zone, wherein the demand data includes a recent time segment having unreliable demand information and the historical demand data represents a demand of consumers for the supply over multiple past time periods in the geographic zone;
based on the demand data, estimating a scalar of the demand over the past time period;
based on the historical demand data, modeling a standardized model demand profile of mean demand over the multiple past time periods;
producing a demand prediction of the consumers of the supply over a forthcoming time period in the geographic zone, wherein the demand prediction is based, at least in part, on the standardized model demand profile and the demand prediction includes, at least in part, a product of the scalar and the standardized model demand profile; and
presenting the demand prediction.

11. A method of claim 10 further comprising:
obtaining consumer data that includes information regarding demand properties and status of the consumers for the supply over the past time period in the geographic zone;
based on the consumer data, generating a standardized capacity profile of capacity over the past time period;
producing a capacity prediction of the consumers of the supply over the forthcoming time period in the geographic zone, wherein the capacity prediction includes, at least in part, a product of the scalar and the standardized capacity profile; and
presenting the capacity prediction.

12. A method of claim 10, wherein the demand data includes a recent time segment having unreliable demand information, the method further comprising:
obtaining consumer data that includes information regarding demand properties and status of the consumers for the supply over the past time period in the geographic zone;
producing a short-term demand prediction of the consumers of the supply over an immediate portion of a forthcoming time period in the geographic zone, wherein the short-term demand prediction is based, at least in part, on the standardized model demand profile, the demand data, and the consumer data and the short-term demand prediction includes, at least in part, being a product of the scalar and the standardized model demand profile; and
presenting the short-term demand prediction.

13. A method of claim 10, wherein the geographic zone includes multiple territories with the short-term demand prediction produced for each territory, the method further comprising generating an aggregated multi-territorial prediction based on the short-term demand predictions produced for each territory.

14. A method of claim 10, wherein the consumers are electrical vehicles that charge using an electrical supply.

15. A method of claim 10 further comprising calculating a confidence interval of the demand prediction as a function of the scalar.

16. A non-transitory machine-readable storage medium encoded with instructions executable by one or more processors that, when executed, direct the one or more processors to perform operations for facilitating a prediction of demand of consumers for a supply in a geographic zone, the operations comprising:
obtaining demand data, consumer data, and historical demand data, the demand data represents a demand of consumers for a supply over a past time period in a geographic zone, wherein the demand data includes a recent time segment having unreliable demand information, the consumer data includes information regarding demand properties and status of the consumers for the supply over the past time period in the geographic zone, and the historical demand data represents a demand of consumers for the supply over multiple past time periods in the geographic zone;
based on the demand data, estimating a scalar of the demand over the past time period;
based on the historical demand data, modeling a standardized model demand profile of mean demand over the multiple past time periods;
producing a short-term demand prediction of the consumers of the supply over an immediate portion of a forthcoming time period in the geographic zone, wherein the short-term demand prediction is based, at least in part, on the standardized model demand profile, the demand data, and the consumer data and the short-term demand prediction includes, at least in part, being a product of the scalar and the standardized model demand profile; and
presenting the short-term demand prediction.

17. A non-transitory machine-readable storage medium of claim 16, the operations further comprising:
producing a demand prediction of the consumers of the supply over the forthcoming time period in the geographic zone, wherein the demand prediction is based, at least in part, on the standardized model demand profile and the demand prediction includes, at least in part, a product of the scalar and the standardized model demand profile; and
presenting the demand prediction.

18. A non-transitory machine-readable storage medium of claim 16, the operations further comprising:
based on the consumer data, generating a standardized capacity profile of capacity over the past time period;
producing a capacity prediction of the consumers of the supply over the forthcoming time period in the geographic zone, wherein the capacity prediction includes, at least in part, a product of the scalar and the standardized capacity profile; and
presenting the capacity prediction.

19. A non-transitory machine-readable storage medium of claim 16, wherein the geographic zone includes multiple territories with the short-term demand prediction produced for each territory, the operations further comprising generating an aggregated multi-territorial prediction based on the short-term demand predictions produced for each territory.

20. A non-transitory machine-readable storage medium of claim 16, wherein the consumers are electrical vehicles that charge using an electrical supply.
